(19) United States
(12) Patent Application Publication
(10) Pub. No.: US 2008/0231928 A1
(43) Pub. Date: Sep. 25, 2008

(54) Optical Scanning Device with Low Building Height

(75) Inventor: Arnoldus J. Stevens, Eindhoven (NL)

Correspondence Address: BAINWOOD HUANG & ASSOCIATES LLC, 2 CONNECTOR ROAD, WESTBOROUGH, MA, 01581, US

(73) Assignee: Arima Devices Corporation TrustNet Chambers, Road Town (VG)

(21) Appl. No.: 11/793,470

(22) PCT Filed: Dec. 19, 2005
(86) PCT No.: PCT/IB05/54301

§ 371 Date: Jun. 3, 2008

(30) Foreign Application Priority Data
Dec. 22, 2004 (EP) 04106842.0

(51) Int. Cl. G02B 26/08

(52) U.S. Cl. 359/196

(57) ABSTRACT

An optical scanning device (20) for low building height optical recorder applications is disclosed in which a radiation source (1) is emitting a radiation beam along a first optical portion (8) towards a folding mirror (4), which folding mirror is reflecting the radiation beam along a second optical path portion (9) towards an optical record carrier (6). The angle between the first and second light path portions is acute.

### FIELD OF THE INVENTION

The invention relates to an optical scanning device according to the preamble of claim 1 and to an optical recording apparatus comprising such an optical scanning device.

### BACKGROUND OF THE INVENTION

Optical storage applications, such as optical recording or data drives, also have a widespread use in portable computer, for example laptops or notebooks. Trends towards thinner and more compact computers have effect on the height requirements for the applied optical recording drives.

Where in this application reference is made to an optical recording or data drive, such a drive is capable of writing and/or reading data from an information layer in or on an optical record carrier. This data can be audio, video, computer data, etc. Recording is to be understood as writing data in an information layer in or on an optical record carrier as well as reading data from an information layer in or on an optical record carrier.

The reduction of the height of an optical scanning device or optical pickup unit (OPU) used in an optical recording drive is preferably without a reduction of the axial stroke of the focusing actuator in the OPU, for example, due to vignetting of the beam by the focusing actuator or objective lens.

One way to achieve a reduction of the building height of the OPU is to use a smaller beam diameter. This results in an OPU in which the optical components are closer together and the optical path length shorter. A disadvantage of a smaller beam diameter is that the functional radial stroke of the actuator for tracking is also reduced as well as that the (opto-) mechanical tolerances in the OPU are becoming tighter.

In Japanese Patent JP-2004234714 a reduction of height is obtained by adding an additional optical component in the OPU. A tilted plan-parallel plate (a beam height changing plate) is designed in the optical path between the radiation source (laser diode) and the (folding-) mirror. The tilted plan parallel plate refracts the parallel radiation beam to a lower position in the OPU. In this way the radiation source can then be positioned slightly higher in the OPU such that its encapsulation is not exceeding the height requirements by sticking out at the bottom of the OPU.

It is an object of the invention to provide a reduction of the building height of an optical scanning device without additional components.

It is also an objective to provide a reduction of the building height of an optical scanning device without additional components utilizing a non-parallel radiation beam.

### SUMMARY OF THE INVENTION

This object is achieved by an optical scanning device for scanning an information layer of an optical record carrier according to the invention, comprising a radiation source emitting radiation beam along a first optical path portion towards a folding means for folding the radiation beam, an objective system adapted for focusing the radiation beam onto the information layer, the folding means folding the radiation beam along a second optical path portion towards the objective system, wherein the angle between the first optical path portion and the second optical path portion being equal or less than 89 degrees.

Tilting the optical path according to the invention does not add additional components into the optical path and is therefore cost effective. Furthermore the solution as provided according to the invention is applicable to OPU's with at least one parallel and/or non-parallel beam directing towards the folding mirror. The invention can therefore advantageously be applied in, for example, DVD/CD or BD/DVD/CD compatible OPU's.

An embodiment of the optical scanning device according to the invention is further characterized in that the scanning device comprises at least two reference positions defining a line for measurements parallel to the first optical path portion.

As the first optical path portion in the optical scanning device is tilted with respect to the information plane, the measurement tools (such as jigs) for the assembly of the optical scanning device may have to be corrected for this tilt angle. When applying reference positions on the OPU the tools can be kept simple and without any corrections in angles. This makes the tooling and tool dimensions verification easier and less expensive.

### DESCRIPTION OF THE DRAWINGS

The preferred embodiments of the invention will be described below with reference to the accompanying drawings. In the drawings:

FIG. 1 schematically shows a layout of a conventional optical scanning device: in FIG. 1A according to an “Egyptian view” and in FIG. 1B in a side view of the optical scanning device,

FIG. 2 schematically shows a layout of an optical scanning device according to the invention,

FIG. 3 schematically shows reference positions on the optical scanning device according to the invention.

### DETAILED DESCRIPTION OF THE INVENTION

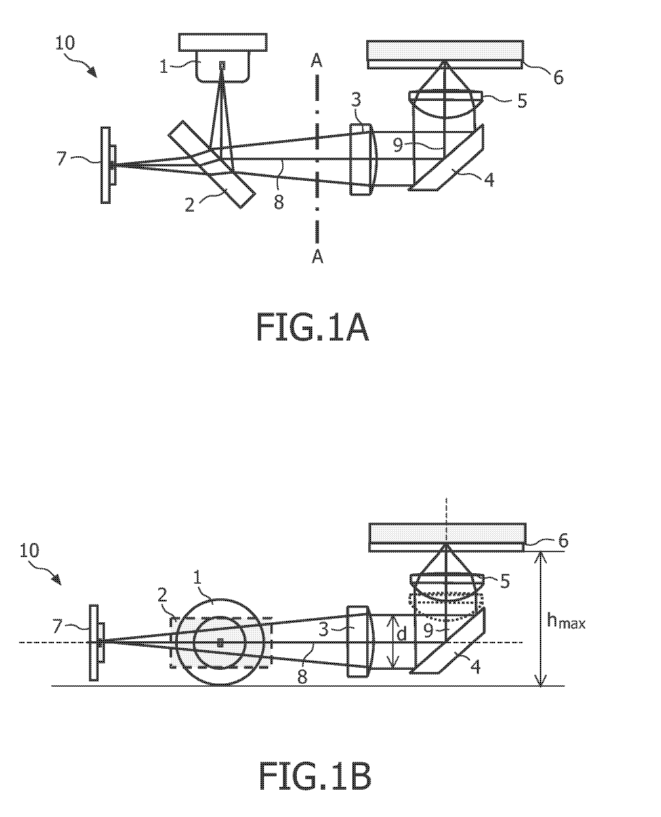

FIG. 1A shows an example of a conventional optical pickup 10 according to an “Egyptian view” showing the relevant components in the same (2-dimensional) plane, while in practice the part of the drawing on the right hand side of the line A-A is rotated 90 degrees out of the plane of the drawing.

In such a conventional optical pickup 10, as depicted in FIG. 1B, some optical, opto-electrical and/or the mechanical components extend to a lower point in the OPU than the lowest portion of the radiation beam directed to the folding mirror 4. Usually this it is the encapsulation or packaging of the radiation source 1 or photodetector 7 that is extending beyond the bottom portion of the radiation beam or OPU. It may also be a flange of a lens 3 (e.g. collimator lens) as the mechanical diameter of the lens including flange is larger than the diameter of the radiation beam.

In such an optical scanning device 10 as depicted in FIGS. 1A and 1B, a radiation source 1 (e.g. a semiconductor laser) emits a divergent radiation beam that is reflected by beam splitter 2 along a first optical path portion 8. The divergent radiation beam may be collimated to a less diverging beam, a parallel beam or converging beam by a lens 3, e.g. a collimator lens. In low building height OPU's such a collimator lens is usually placed between the radiation source and the folding mirror 4. The folding mirror 4 reflects the radiation beam along a second optical part portion 9 towards the objective lens 5. Folding mirror 4 has a reflective surface at an angle of 45 degrees with the information layer. The objective lens 5 focuses the radiation beam onto an information layer of an optical record carrier 6. The objective lens may be a single lens or a system of lenses and is mounted in an actuator (not shown). This actuator maybe used for focusing the optical radiation beam onto the information layer 6 and for tracking in the radial direction.

The radiation reflected by the information layer is transmitted through the objective lens 5, reflected by the folding mirror 4, transmitted by the collimator lens 3 and the beam splitter 2 towards the photodetector 7. With the photodetector 7 tracking signals such as a focus-signal and a radial-signal are obtained using common methods as the astigmatic focusing method and the push-pull radial tracking method. Depending on the tracking signal generation chosen for, also additional optical components may be required in the optical pickup (e.g. grating, wedge-prism, sensor lens, etc.).

In such a conventional optical pickup the design of the first optical path portion is parallel to the information plane of the record carrier and the second optical path portion is designed perpendicular to the information plane of the optical record carrier. Thus resulting in an angle between the first and second optical path portions of 90 degrees. As a result (electro-) optical components such as for example the radiation source, the photodetector or the collimator lens will extend beyond the lowest position of the radiation beam incident on the folding mirror; thereby increasing the total height of the OPU beyond the lowest part of the radiation beam incident on the folding mirror. This is depicted in FIG. 1B, showing a schematic side view of OPU 10. When the total building height of the OPU is restricted to a maximum hₘₐₓ and the (electro-)optical and mechanical components are the height limiting elements, vignetting of the radiation beam by the actuator or objective lens may occur. This may occur when the actuator is at a low position due to an axial stroke (focusing direction) as is shown by the dashed lower positioned objective lens 5. To avoid such vignetting non-preferable countermeasures have to be taken, such as, limiting the range for the axial stroke, increasing the allowable height of the OPU, or reducing the beam diameter.

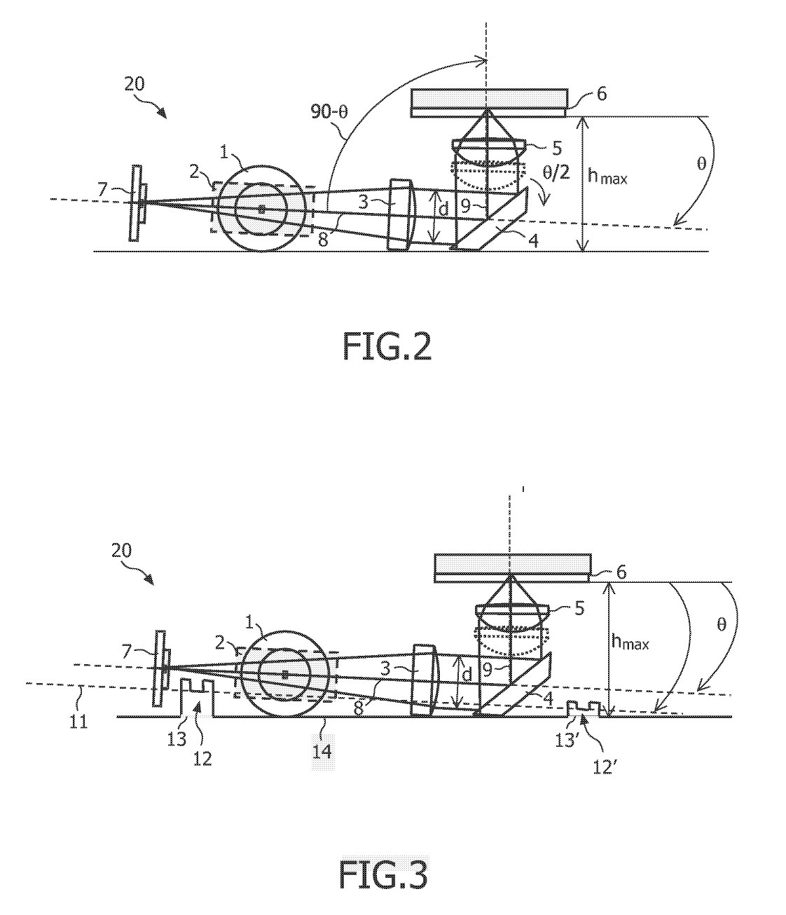

In FIG. 2 the schematics of an OPU 20 according to an embodiment of the invention is shown. A first optical part portion 8 is designed with a tilt angle θ to the information layer of the optical record carrier 6. The first optical path portion 8 is tilted around a point on the reflecting surface of the folding mirror 4. The second optical path portion 9 may still be designed (substantially) perpendicular to the information layer of the record carrier 6. The total height of the OPU 20 is still hₘₐₓ. However, there are no components extending below that level; the tilt angle θ is in FIG. 2 just large enough to avoid this. It is obvious that when possible and required the tilt angle θ can be made larger. To have the second optical path portion 9 perpendicular to the information layer of the optical record carrier 6, the folding mirror 4 is to be rotated over an angle of θ/2 degrees with respect to the design as shown in FIG. 1B.

One could also refer to an optical path design in which the angle between the first optical path portion and the second optical path portion is equal to 90-θ degrees. Depending on the dimensions of the applied (electro-) optical components this tilt angle θ is about 1 or more degrees. Although this seems to be a small angle, the effect on the height of the position of e.g. the photodetector in the OPU can be substantial; for example, a realistic optical path length of 25 mm from folding mirror 4 to photodetector 7 results in about 0.4 mm shift of height compared to a non-rotated first optical path portion. This shift of about 0.4 mm is substantial when considering the maximum height hₘₐₓ for an OPU for an ultra-slim optical data drive to be about 5.4 mm or lower.

The folding mirror 4 may in this case be rotated in the design to compensate for the tilt angle by 0.5 degrees. In practical manufacturing of OPU's the mounting tolerances of a folding mirror is in the order of about 0.1 degrees, which is significantly lower than the values required according to the invention.

The folding mirror as described in the above examples is based on reflection at a surface from a reflective optical element; however, it is to be understood that the function of such a means for folding the radiation beam towards another direction may also be achieved by means of refractive optical element or diffractive optical element (e.g. a blazed grating or hologram).

As shown in FIG. 2, the folding mirror may also be lowered to reduce the occurrence of vignetting of the radiation beam incident on the folding mirror by the objective lens in the actuator in a lower position of its axial (focusing) stroke.

The optical components and/or their mechanical or mounting references along the first optical path portion may be designed for operation in combination with the tilt angle θ.

Although the above examples are described with reference to an OPU obtaining a single radiation source, it is obvious that the invention also applies for optical scanning devices applying multiple radiation sources. Such OPU's may be usable for scanning multiple optical record carrier formats such as, for example, CD and DVD, DVD and BD or CD, DVD and BD (or other record carrier formats).

The invention as disclosed is also applicable to increase the design value of the beam diameter in an OPU such as used in standard height PC-notebooks or even desktop PC's. Advantages of a larger beam diameter are for example increased (opto-) mechanical tolerances for the OPU or it optical components. Especially when a multiple disk-format compatible OPU is to be designed for CD, DVD and BD format application. As the beam diameters of the BD-beam, DVD-beam and CD-beam scale with the numerical aperture of the objective lens, the beam diameter of the CD-beam will be about 1.7 times smaller than the beam diameter of the BD-beam.

Also applications in which a larger axial (focus) stroke of the objective lens than normally applied is required (such as for label writing on a flipped optical record carrier with an optical recording drive) may benefit from the presented invention.

In practice there are also mechanical limitations at the topside of the OPU (i.e. side of the disc). The tilt angle θ for the first optical path portion will therefore be limited at a certain minimum. This minimum is amongst others strongly depending on the length of the first optical path portion. When making used integrated optical components such a hologram-laser units or the like and small beam-diameters, the first optical path length can be made very short. Such a very short first optical path length then may results in a relative small tilt angle θ. It is expected that such minimum tilt angles are larger than 45 degrees. As a maximum range 89<θ<45 degrees may be used.

For OPU's with not so strong height requirements on hₘₐₓ (such as for example for desktop computers) and practical first optical path portions that are about 15 mm the minimum angle for θ may be some 70 degrees. This then results in a range of 89<θ<70 degrees.

In practice the lower value may however be somewhat larger as the requirements on a minimum value for the beam diameter or focal length of lenses can result in a first optical length that is 15 mm or longer. For ultra slim optical pickups the available space at the top of the OPU is said to be also limited. Applying small diameter laser packages and or lenses the expected minimum tilt angle in ultra slim optical pickup devices may be some 80 degrees. This results then in more preferable range of 89<θ<80 degrees.

In another embodiment according to the invention, the optical scanning device according to the invention comprises at least two references positions defining a line parallel to the first optical path portion. FIG. 3 shows an example of this embodiment. The at least two reference positions 12, 12′ define a line 11 parallel to the tilted first optical path portion 8. The reference positions can be used to mount the OPU 20 in the measurement jigs in the assembly line of the OPU or in the measurement tools for dimensional measurements on the OPU. The optical path portion 8 may then be oriented parallel to the information plane 6 or optical record carrier in the measurement or assembly setup. The angle θ for the tilted optical part portion 8 is then corrected. In this way it may be possible to use the same measurement jigs or tooling as for OPU's not having a tilted first part portion. Having such a correction in the OPU available it may be easier to measure for example beam-angle or component mounting positions and angles.

The at least two reference positions may have any appearance, for example accurately machined surface areas or bumps anywhere on the OPU such as for example at the top or at the bottom of the OPU. Preferably these reference positions are located in a recess 13, 13′ at for example the top or bottom of the OPU 20 there is no effect on the height of the optical pickup unit: the total building height can remain within the limit of hₘₐₓ. This is schematically shown in FIG. 3 where such reference positions 12, 12′ are located in recesses 13, 13′ at the bottom of the OPU. Another suitable locations for such reference positions may be near or on the bearings of the OPU.

The invention may also be applied to optical scanning devices for optical recording storage drives to be used in computer applications, such as slim and ultra-slim notebook computers or game computers, as well as in other applications with using optical recording storage drives such as MP-3 players, image and/or video capturing applications in mobile phones, cameras, etc.

1. An optical scanning device for scanning an information layer of an optical record carrier, the optical scanning device comprising:
a radiation source for emitting a radiation beam along a first optical path portion towards a radiation beam folding element for folding the radiation beam,
an objective system being arranged for focusing the radiation beam onto the information layer,
the radiation beam folding element being arranged for folding the radiation beam along a second optical path portion towards the objective system, the radiation beam folding element having a radiation beam folding element lowest portion,
the optical scanning device having a total building height hₘₐₓ being the height between the lowest portion of the optical scanning device and the optical record carrier to be scanned, wherein an angle between the first optical path portion and the second optical path portion is such that hₘₐₓ is determined by the radiation beam folding element lowest portion.

2. An optical scanning device according to claim 1, wherein the angle between the first optical path portion and the second optical path portion is equal to or less than 89 degrees.

3. An optical scanning device according to claim 1, wherein the angle between the first optical path portion and the second optical path portion is larger than 45 degrees.

4. An optical scanning device according to claim 3, wherein the angle between the first optical path portion and the second optical path portion is larger than 70 degrees.

5. An optical scanning device according to claim 3, wherein the angle between the first optical path portion and the second optical path portion is larger than 80 degrees.

6. An optical scanning device according to claim 1, wherein the optical scanning device comprises at least two reference positions defining a line parallel to the first optical path portion.

7. An optical scanning device according to claim 6, wherein the at least two reference positions are located in a recess of the device.

8. An optical scanning device according to claim 1, wherein the radiation beam folding element is a reflective optical element.

9. An optical scanning device according to claim 1, wherein the radiation beam folding element is a diffractive optical element.

10. An optical recording apparatus, comprising an optical scanning device according to claim 1.

11. An optical scanning device for scanning an information layer of an optical record carrier, the optical scanning device comprising:
a radiation source for emitting a radiation beam along a first optical path portion towards a radiation beam folding element for folding the radiation beam,
an objective system being arranged for focusing the radiation beam onto the information layer,
the radiation beam folding element being arranged for folding the radiation beam along a second optical path portion towards the objective system,
wherein an angle between the first optical path portion and the second optical path portion is acute.

12. An optical scanning device according to claim 11, wherein the angle between the first optical path portion and the second optical path portion is equal to or less than 89 degrees.
